(19) United States
(12) Patent Application Publication
(10) Pub. No.: US 2019/0294792 A1
(43) Pub. Date: Sep. 26, 2019

(54) LIGHTWEIGHT MALWARE INFERENCE ARCHITECTURE

(71) Applicant: Cisco Technology, Inc., San Jose, CA (US)

(72) Inventors: Abhishek Singh, Pleasanton, CA (US); Debojyoti Dutta, Santa Clara, CA (US)

(21) Appl. No.: 16/102,571

(22) Filed: Aug. 13, 2018

Related U.S. Application Data
(60) Provisional application No. 62/645,389, filed on Mar. 20, 2018.

(51) Int. Cl. G06F 21/56; G06F 21/57; H04L 29/06; G06K 9/62; G06N 5/04; G06F 15/18

(52) U.S. Cl. CPC G06F 21/563; G06F 21/577; H04L 63/1416; G06F 2221/033; G06K 9/6281; G06N 5/04; G06F 15/18; H04L 63/1433

(57) ABSTRACT

Systems, methods, computer-readable media, and devices are disclosed for creating a malware inference architecture. An instruction set is received at an endpoint in a network. At the endpoint, the instruction set is classified as potentially malicious or benign according to a first machine learning model based on a first parameter set. If the instruction set is determined by the first machine learning model to be potentially malicious, the instruction set is sent to a cloud system and is analyzed at the cloud system using a second machine learning model to determine if the instruction set comprises malicious code. The second machine learning model is configured to classify a type of security risk associated with the instruction set based on a second parameter set that is different from the first parameter set.

### CROSS-REFERENCE TO RELATED APPLICATIONS

This application claims priority to U.S. Provisional Patent Application No. 62/645,389, filed Mar. 20, 2018, entitled “LIGHTWEIGHT MALWARE INFERENCE ARCHITECTURE,” the contents of which is incorporated herein by reference in its entirety.

### FIELD

The present invention generally relates to computer networking, and more particularly to the use of machine learning models to improve cloud security.

### BACKGROUND

Malware, short for malicious software, is an umbrella term used to refer to a variety of forms of hostile or intrusive software, including computer viruses, worms, Trojan horses, ransomware, spyware, adware, scareware, and other harmful programs. It can take the form of executable code, scripts, active content, and other software. Programs supplied officially by companies can be considered malware if they secretly act against the interests of the computer user. Malware, therefore, need not have an express intent to harm a customer's computer—a harmful effect poses just as great a security risk. For example, a rootkit, such as a Trojan horse embedded into CDs sold to customers, can be silently installed and then concealed on purchasers' computers with the intention of preventing illicit copying. However, the same rootkit can also report on users' listening habits, and unintentionally create vulnerabilities that can be exploited by unrelated malware.

Antivirus software and firewalls are used to protect against such malicious activity, either intentional or unintentional, and to recover from attacks. A specific component of anti-virus and anti-malware software, commonly referred to as on-access or real-time scanners, hooks deep into the operating system's core or kernel and functions in a manner similar to how certain malware itself would attempt to operate, though with the user's informed permission for protecting the system. Any time the operating system accesses a file, the on-access scanner checks if the file is a ‘legitimate’ file or not. If the file is identified as malware by the scanner, the access operation will be stopped, the file will be dealt with by the scanner in a pre-defined way (how the anti-virus program was configured during/post installation), and the user can be notified. However, antivirus software and firewalls may have a considerable performance impact on the operating system, and the degree of impact is dependent on how well the scanner was programmed and how quickly the scanner executes. It is desirable to stop any operations the malware may attempt on the system, including before they occur, such as malware activities and operations which might exploit bugs or trigger unexpected operating system behavior.

Current anti-malware programs combat malware in two ways: (1) the anti-malware software scans all incoming network data for malware and blocks any threats it comes across, either all at once or in batches; and (2) anti-malware software programs scan the contents of the Windows registry, operating system files, and installed programs on a computer and will provide a list of any threats found, allowing the user to choose which files to delete or keep, or to compare this list to a list of known malware components and removing files that match.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example schematic for a malware inference architecture in accordance with some embodiments;

FIG. 2 is a flow chart illustrating a method for a malware inference architecture in accordance with some embodiments; and

FIG. 3 shows an example of a system for implementing certain aspects of the present technology.

### DESCRIPTION OF EXAMPLE EMBODIMENTS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview:

Systems, methods, computer-readable media, and devices are disclosed for creating a malware inference architecture. In some embodiments, an instruction set is received at an endpoint in a network. At the endpoint, the instruction set is classified as potentially malicious or benign according to a first machine learning model based on a first parameter set. If the instruction set is determined by the first machine learning model to be potentially malicious, the instruction set is sent to a cloud system and is analyzed at the cloud system using a second model to determine if the instruction set comprises malicious code. The second model is configured to classify a type of security risk associated with the instruction set based on a second parameter set that is different from the first parameter set.

### Example Embodiments

Aspects of the disclosed technology address the need for providing fast, lightweight malware detection models that can be deployed on an endpoint while not sacrificing the accuracy of the malware detection. Malware can be software or instruction sets that are malicious or otherwise harmful, either intentionally or unintentionally harmful. Due to memory and compute costs, heavyweight anti-malware systems are often infeasible to deploy at network endpoints, especially when the target data of analysis is transmitted in bulk or streaming on a real time or near real time basis. In some cloud security deployments, heavyweight deep learning models are essential to providing high enough accuracy in detecting threats—however, due to compute constraints and high memory requirements, their power cannot be leveraged on endpoints. Such barriers force cloud based service providers to choose between performance and security (e.g., by marginalizing accuracy) for network endpoints.

The foregoing problems of conventional malware systems are addressed by providing an architecture for performing filtering at a low compute cost, while simultaneously achieving high accuracy (e.g., consistent with a heavy-weight deep learning model), by employing a shallow model to filter data for a deep model.

Specifically, in some embodiments a malware inference architecture performs a multiple step process, where an endpoint network device performs filtering using the shallow model at a low compute cost and then forwards potential malware to the cloud, which can utilize a heavy-weight deep learning model with high accuracy. In this way, the multiple step process can achieve both low latency and high accuracy by decoupling threat filtering from a final classifier's decision in a distributed setting. In some embodiments, the shallow model can be biased towards false positives, so that in the case of any doubt, software can be tagged as potentially malicious and verified with the heavy-weight deep learning model (ensuring that no actual malware is missed).

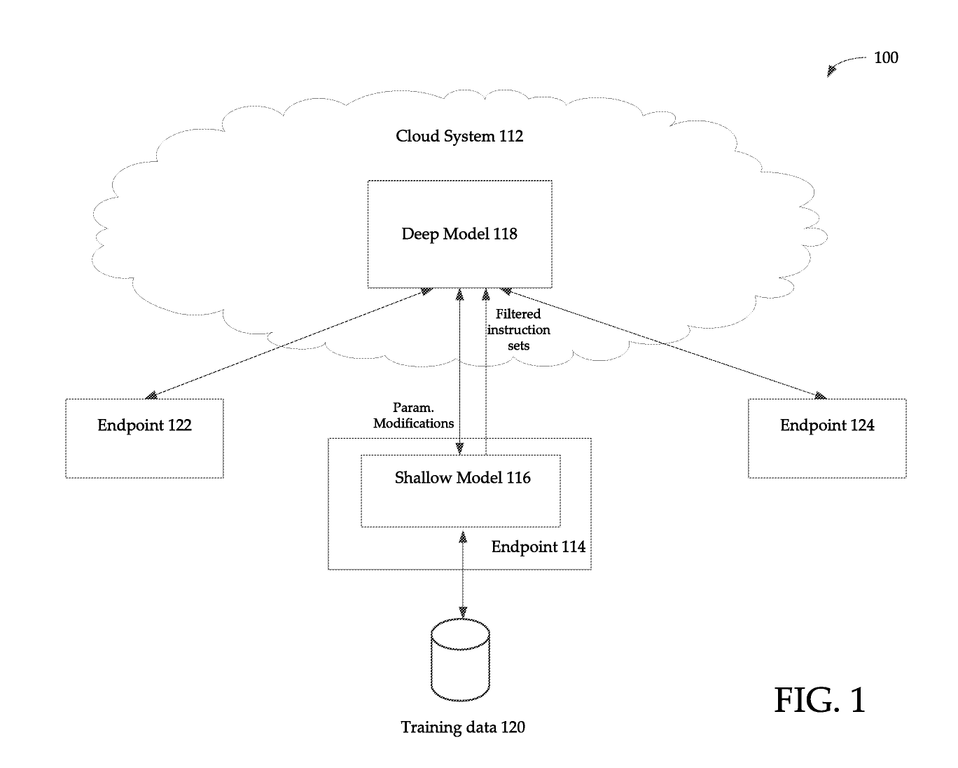

FIG. 1 shows an example schematic for a malware inference architecture in accordance with some embodiments. System 100 illustrates the malware inference architecture where a shallow model for filtering potential malware is decoupled from a deep model that provides a final classification of the potential threat. System 100 includes cloud system network (cloud system 112) that includes one or more devices (not shown) in communication with one or more endpoints (e.g., endpoints 114, 122, 124) in a network. Each endpoint, such as endpoint 114, can be configured to execute a shallow model 116 that analyzes instruction sets to identify and classify instruction sets that could potentially constitute malware and would therefore be good candidates for analysis by a more robust malware detection model, such as deep model 118. That is, if a given instruction set is determined to be of likely relevance to deep model 118, it is passed from shallow model 116 on endpoint 114 to a more robust deep model 118 on cloud system 112, where it can be processed more fully. Thus, while deep model 118 may take more time and more compute resources to execute, deep model 118 only analyzes what shallow model 116 classifies as relevant, thereby significantly narrowing the set of classification inputs provided to deep model 118. This approach saves time and compute resources without sacrificing accuracy. As such, machine learning models can be deployed to provide security solutions at network endpoints which often have limited computing resources, while also leveraging the high accuracy provided by deep learning classifiers that have access to greater compute resources in the cloud.

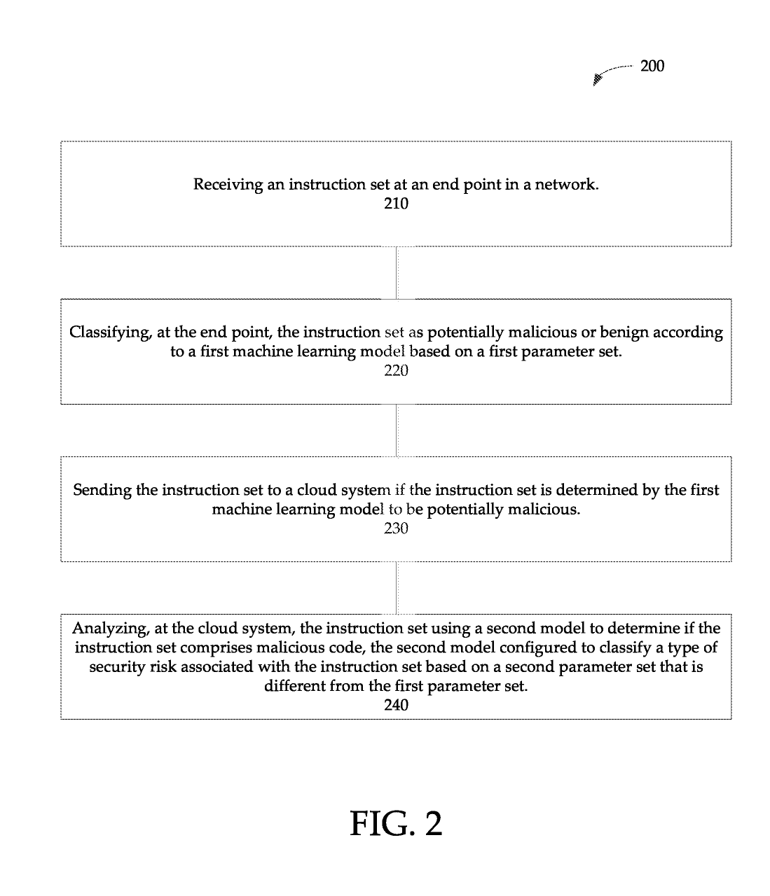

FIG. 2 is a flow chart illustrating a method for the malware inference architecture of FIG. 1 in accordance with some embodiments. Malware detection begins when an instruction set is received or detected at an endpoint, such as endpoint 114 (step 210). Services on endpoint 114, such as shallow model 116, can filter or detect that the instruction set may be potentially malicious or benign according to a quickly executing machine learning model based on one or more parameters in a shallow model parameter set (step 220). In other words, shallow model 116 can determine if a particular instruction set is relevant for further processing on deep model 118.

For example, in some embodiments the shallow model 116 can be a set of rules that identify different groups and/or behaviors relevant to known malware types. For example, the set of rules can be related to parameters that recognize malware signatures or monitor program execution events exhibiting malware behavior, such as parameters including, but not limited to: APIs called, instructions executed, IP addresses accessed, etc. In some embodiments, the shallow model 116 can be applied to executable files with only the raw byte sequence of the executable as input.

Shallow model 116 can preserve speed and low latency by providing a first filtering pass on differentiating between malicious and benign instruction sets at endpoint 114, and determining which instructions sets are relevant for further analysis and/or classification. In some embodiments, shallow model 116 can have a lower accuracy, but shorter computation time, than deep model 118 in cloud system 112. In some embodiments, the instruction set can be filtered and/or initially determined as relevant for further analysis based on meeting one or more of the parameters within the shallow model parameter set at, or above, a threshold value. For example, one or more parameters of shallow model 116 can determine a particular instruction set to be potentially malware based on the shallow model 116 determining that the instruction set has a probability of being malicious at, or over, 65% for one or more shallow model parameters.

According to an example, a particular instruction set in an application may, in its code or when executed, attempt to access a certain IP address. When the instruction set is analyzed by shallow model 116 using its set of parameters, shallow model 116 can determine that, based on the type of application, the IP address being accessed is valid—for example, the application may be a weather application that accesses an IP address associated with a weather database. In that case, the method ends there and the instruction set is not forwarded to deep model 118, i.e., it is determined/classified as code that is not relevant to deep learning model 118. However, in some instances the shallow model 116 may determine that the IP address is suspicious—perhaps because the IP address is associated with a server outside the network that has nothing to do with the application's type, attempts to establish a connection with an unknown outside server to download or upload information, etc. In those instances, the shallow model 116 can forward the instruction set to the deep model 118, which can confirm, and, if the instruction set is further determined to be malware, classify the type of malware. For example, if the deep model 118 determines that the IP address constitutes a valid IP address after all based on its different parameter set, the method ends. But if the deep model 118 confirms that the IP address should not be accessed, the deep model 118 can flag, classify, or otherwise notify cloud system 112 that the instruction set constitutes malware.

In some embodiments, since shallow model 116 is less accurate in favor of speed, shallow model 116 can be biased in favor of false positives. Since speed, and not accuracy, is optimized in shallow model 116, the threshold for potential malware classification can be set fairly low (e.g., a threshold at 30% probability) and/or the shallow model 116 can be penalized in training if it predicts a false negative as compared to a false positive. If shallow model 116 is more penalized for false negatives, shallow model 116 can overestimate potentially malicious instruction sets to be sent to deep model 118. In that way, false negatives for true malware will be minimized or removed.

Those instruction sets that are determined to be potentially malicious by shallow model 116 can be sent to cloud system 112 (step 230) (e.g., sent to deep model 118) for further analysis and/or classification. Deep model 118 is deployed with high accuracy on cloud 112 to differentiate between true positive threats captured by shallow model 116 from true negatives. Deep model 118, for example, can be one or more machine learning techniques based on a deep network, which may execute more slowly than shallow model 116. Deep model 118 can be based on a set of parameters that are different from the set of parameters used for shallow model 116. For example, in some embodiments deep model 118 can have a larger set of parameters than shallow model 116; however, in other embodiments the number of parameters may be the same or lower, but different than shallow model 116. Regardless of the number of parameters, the rules and/or parameters of deep model 118 can provide a more thorough pass on differentiating between malicious and benign instruction sets at endpoint 114 (e.g., rules and/or parameters related to APIs called, instructions executed, IP addresses accessed, etc.). For example, deep model 118 can be configured to not only verify that an instruction set is malware, but also classify a type of security risk associated with the instruction set based on a parameter set that is different from the shallow model's 116 parameter set. Specifically, deep model 118 can include a greater number of rules and/or parameters than shallow model 116. Moreover, in some embodiments deep model 118 can include rules and/or parameters that can be dynamically modified as instruction sets are applied to it, so that deep model 118 evolves over time to become more accurate.

After receiving the filtered instruction sets from endpoint 114, cloud system 112 can then analyze the instruction set using deep model 118 to verify if the instruction set comprises malicious code (step 240). While deep model 118 may execute more slowly than shallow model 116, the aggregate computational time is decreased since the instruction sets sent to deep model 118 has been filtered or otherwise reduced in size.

In some embodiments, the models can be trained beforehand and on a real time or near real time basis. For example, shallow model 116 can be trained with a set of training data 120 at endpoint 114. The parameter budget of the shallow parameter set in shallow model 116, for example, can be fixed as constant in some embodiments, causing the size of the shallow model 116 to remain below a threshold size. The parameter budget can be set either manually or automatically based on speed considerations (e.g., the execution speed of shallow model 116). Shallow model 116 can be further refined at endpoint 114 by modifying, based on threshold values of one or more deep models parameters (optimized for malicious instruction detection), one or more corresponding parameters in shallow model 116. For example, deep model 118 can send modified parameters to shallow model 116 for adoption on the next instruction set(s).

In one implementation, the disclosed technology involves training deep model 118 as well as shallow model 116 or in conjunction with shallow model 116. In some aspects, rather than training the shallow model 116 with only ground truth training data, training is performed on outputs of the deep model 118, which helps the shallow model 116 learn appropriate data representations. Deep model 118, for example, can be trained with a high number of parameters that can extract the best possible relevant information from data (e.g., malware, network traffic, etc.) with high accuracy. Once deep model 118 is trained and tested for correctness, the shallow model 116 is trained and deployed with one or more shallow model parameters set by the trained deep model 118. To keep the size of the shallow model 116 minimal, a fixed parameter budget of the shallow model 116 can be set.

To mitigate the potential for accuracy loss, the training paradigm of shallow model 116 can act as a good filter, rather than as an explicit classifier. For example, the training paradigm can enable shallow model 116 to make a simplified, binary determination of whether an instruction set is potentially malicious or not (such as whether the instruction set would be relevant to the slower, but more accurate, deep model 118)—and not a determination of what kind of malware the instruction set may be. Such training paradigms can be made by changing the way in which the neural networks for shallow model 116 is trained. In some implementations, a loss function (e.g., any method known by a person having ordinary skill in the art of determining how well a model accurately measures the dataset) can be modified by adding a bias towards false negatives. This method penalizes the shallow model 116 relatively more if it predicts a false negative as compared to a false positive. Such penalties enforce the capture of true positives in a broad decision boundary, which also leads to overfitting and an increased false positive rate. In this way, all instruction sets that may be potential malware will be more rigorously analyzed and classified by deep model 118.

Any loss function that provides a penalty for an incorrect classification of an example can be used to mitigate accuracy loss. One example of a loss function is shown below, where the loss function can be defined by:

$$\frac{\partial C}{\partial {z}_{i}} = \frac{1}{{T}_{i}} ( \frac{{e}^{\frac{{z}_{i}}{{T}_{i}}}}{\sum {je}^{\frac{{z}_{j}}{{T}_{j}}}} - \frac{{e}^{\frac{{v}_{i}}{{T}_{i}}}}{\sum {je}^{\frac{{v}_{j}}{{T}_{j}}}} ) \qquad ( 1 )$$

Where zᵢ is the output logit by the student model (e.g., shallow model 116) and vᵢ is the output logit of the teacher model (e.g., deep model 118). T, also known as temperature, can affect the gradient of neurons during back-propagation and is projected into an N dimensional vector such as:

T∈R^{N} (2)

Where R^{N} is an N dimensional space of real numbers. Using equations (1)-(2), the training paradigm can over fit and increase a false positive rate in order to bias the shallow model 116 to false positives. Equation (1) relaxes the constant temperature constraint for all output labels and, by doing so, the gradient obtained for some of the output labels can be made high and for other labels can be made low. In the case of a malware filter, where the aim is to capture the maximum number of malicious samples while allowing few benign examples as well, the value Tᵢ can be made small for the output labels corresponding to malware and Tᵢ can be made large for the output labels corresponding to benignware.

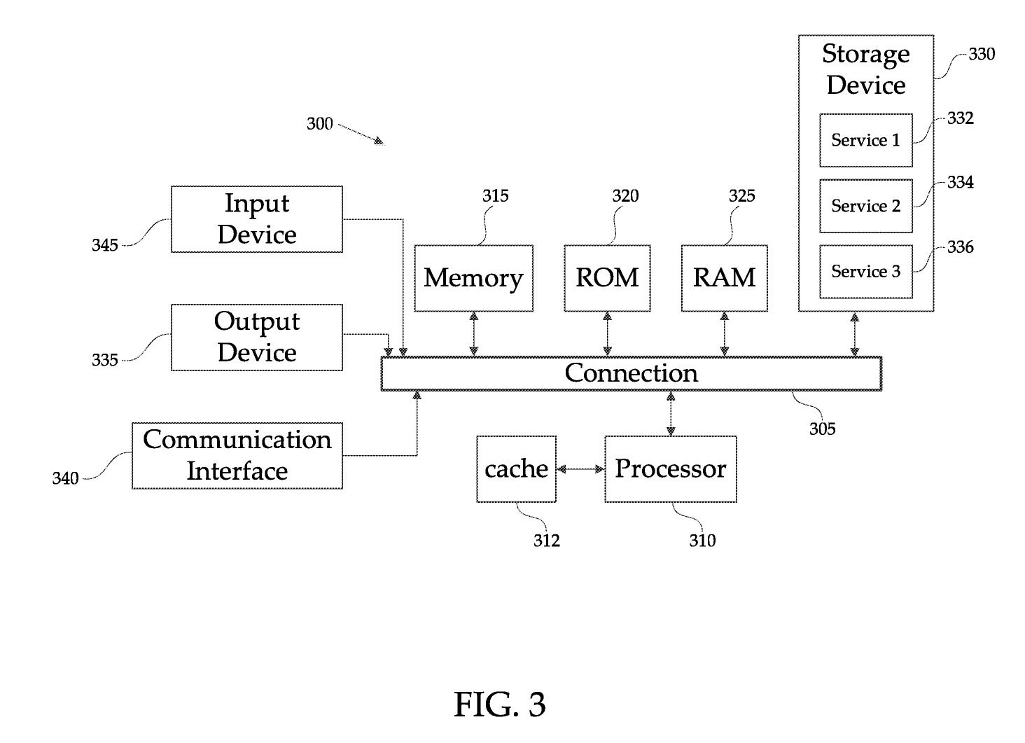

FIG. 3 shows an example of computing system 300 in which the components of the system shown in FIG. 2 are in communication with each other using connection 305. Connection 305 can be a physical connection via a bus, or a direct connection into processor 310, such as in a chipset architecture. Connection 305 can also be a virtual connection, networked connection, or logical connection.

In some embodiments computing system 300 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 300 includes at least one processing unit (CPU or processor) 310 and connection 305 that couples various system components including system memory 315, such as read only memory (ROM) and random access memory (RAM) to processor 310. Computing system 300 can include a cache of high-speed memory connected directly with, in close proximity to, or integrated as part of processor 310.

Processor 310 can include any general purpose processor and a hardware service or software service, such as services 332, 334, and 336 stored in storage device 330, configured to control processor 310 as well as a special-purpose processor where software instructions are incorporated into the actual processor design. Processor 310 may essentially be a completely self-contained computing system, containing multiple cores or processors, a bus, memory controller, cache, etc. A multi-core processor may be symmetric or asymmetric.

To enable user interaction, computing system 300 includes an input device 345, which can represent any number of input mechanisms, such as a microphone for speech, a touch-sensitive screen for gesture or graphical input, keyboard, mouse, motion input, speech, etc. Computing system 300 can also include output device 335, which can be one or more of a number of output mechanisms known to those of skill in the art. In some instances, multimodal systems can enable a user to provide multiple types of input/output to communicate with computing system 300. Computing system 300 can include communications interface 340, which can generally govern and manage the user input and system output. There is no restriction on operating on any particular hardware arrangement and therefore the basic features here may easily be substituted for improved hardware or firmware arrangements as they are developed.

Storage device 330 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 330 can include software services, servers, services, etc., that when the code that defines such software is executed by the processor 310, it causes the system to perform a function. In some embodiments, a hardware service that performs a particular function can include the software component stored in a computer-readable medium in connection with the necessary hardware components, such as processor 310, connection 305, output device 335, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for creating a malware inference architecture comprising:
receiving an instruction set at an endpoint in a network;
classifying, at the endpoint, the instruction set as potentially malicious or benign according to a first machine learning model based on a first parameter set;
sending the instruction set to a cloud system if the instruction set is determined by the first machine learning model to be potentially malicious; and
analyzing, at the cloud system, the instruction set using a second machine learning model to determine if the instruction set comprises malicious code, the second machine learning model configured to classify a type of security risk associated with the instruction set based on a second parameter set that is different from the first parameter set.

2. The method of claim 1, further comprising biasing the first machine learning model in favor of false positives, wherein the first machine learning model is penalized in training if it predicts a false negative as compared to a false positive such that the first machine learning model overestimates potentially malicious instruction sets, and wherein false negatives for true malicious instruction sets is minimized.

3. The method of claim 1, wherein the instruction set is filtered based on meeting one or more parameters of the first parameter set of the first machine learning model above a threshold value.

4. The method of claim 1, further comprising:
training the first machine learning model with a set of training data at the endpoint, wherein a parameter budget of the first parameter set is fixed as constant, causing a size of the first machine learning model to remain below a threshold size; and
refining the first machine learning model at the endpoint by modifying, based on threshold values for the second parameter set of the second machine learning model optimized for malicious instruction detection, one or more corresponding parameters in the first parameter set.

5. The method of claim 1, wherein the first machine learning model is decoupled from the second machine learning model, such that classifying potential threats by the first machine learning model is decoupled from a final classification of a threat within the instruction set by the second machine learning model.

6. The method of claim 1, wherein the second machine learning model is a deep network based on one or more machine learning techniques, and the second parameter set is greater than the first parameter set.

7. The method of claim 1, wherein the first machine learning model has a lower accuracy, but shorter computation time, than the second machine learning model.

8. The method of claim 1, wherein the second parameter set is comprised of a number of parameters that dynamically modifies a number of parameters associated with the second machine learning model.

9. A system for creating a malware inference architecture, the system comprising:
an endpoint in a network that:
receives an instruction set;
classifies the instruction set as potentially malicious or benign according to a first machine learning model based on a first parameter set; and
a cloud system network comprising a set of devices and a communication interface in communication with the endpoint, wherein a subset of the set of devices:
receives the instruction set if the instruction set is determined by the first machine learning model to be potentially malicious; and
analyzes the instruction set using a second machine learning model to determine if the instruction set comprises malicious code, the second machine learning model configured to classify a type of security risk associated with the instruction set based on a second parameter set that is different from the first parameter set.

10. The system of claim 9, wherein the endpoint further biases the first machine learning model in favor of false positives, wherein the first machine learning model is penalized in training if it predicts a false negative as compared to a false positive such that the first machine learning model overestimates potentially malicious instruction sets, and wherein false negatives for true malicious instruction sets is minimized.

11. The system of claim 9, wherein the instruction set is filtered based on meeting one or more parameters of the first parameter set of the first machine learning model above a threshold value.

12. The system of claim 9, wherein the endpoint further:
trains the first machine learning model with a set of training data, wherein a parameter budget of the first parameter set is fixed as constant, causing a size of the first machine learning model to remain below a threshold size; and
refines the first machine learning model at the endpoint by modifying, based on threshold values for the second parameter set of a second machine learning model optimized for malicious instruction detection, one or more corresponding parameters in the first parameter set.

13. The system of claim 9, wherein the first machine learning model is decoupled from the second machine learning model, such that classifying potential threats by the first machine learning model is decoupled from a final classification of a threat within the instruction set by the second machine learning model.

14. The system of claim 9, wherein the second machine learning model is a deep network based on one or more machine learning techniques, and the second parameter set is greater than the first parameter set.

15. The system of claim 9, wherein the first machine learning model has a lower accuracy, but shorter computation time, than the second machine learning model.

16. The system of claim 9, wherein the second parameter set is comprised of a number of parameters that dynamically modifies a number of parameters associated with the second machine learning model.

17. A non-transitory computer-readable medium comprising instructions stored thereon, the instructions executable by one or more processors of a computing system to perform a method for creating a malware inference architecture, the instructions causing the computing system to:
receive an instruction set at an endpoint in a network;
classify, at the endpoint, the instruction set as potentially malicious or benign according to a first machine learning model based on a first parameter set;
send the instruction set to a cloud system if the instruction set is determined by the first machine learning model to be potentially malicious; and
analyze, at the cloud system, the instruction set using a second machine learning model to determine if the instruction set comprises malicious code, the second machine learning model configured to classify a type of security risk associated with the instruction set based on a second parameter set that is different from the first parameter set.

18. The non-transitory computer-readable medium of claim 17, the instructions further causing the computing system to bias the first machine learning model in favor of false positives, wherein the first machine learning model is penalized in training if it predicts a false negative as compared to a false positive such that the first machine learning model overestimates potentially malicious instruction sets, and wherein false negatives for true malicious instruction sets is minimized.

19. The non-transitory computer-readable medium of claim 17, wherein the instruction set is filtered based on meeting one or more parameters of the first parameter set of the first machine learning model above a threshold value.

20. The non-transitory computer-readable medium of claim 17, the instructions further causing the computing system to:
train the first machine learning model with a set of training data at the endpoint, wherein a parameter budget of the first parameter set is fixed as constant, causing a size of the first machine learning model to remain below a threshold size; and
refine the first machine learning model at the endpoint by modifying, based on threshold values for the second parameter set of the second machine learning model optimized for malicious instruction detection, one or more corresponding parameters in the first parameter set.
